(19) United States
(12) Patent Application Publication
(10) Pub. No.: US 2010/0101385 A1
(43) Pub. Date: Apr. 29, 2010

(54) METHOD AND APPARATUS FOR OPERATING A MICROTOME

(75) Inventors: Roland Walter, Reilingen (DE); Andreas Laudat, Meckesheim (DE); Annett Leonhardt, Meckesheim (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA BIOSYSTEMS NUSSLOCH GMBH, Nussloch (DE)

(21) Appl. No.: 12/580,197

(22) Filed: Oct. 15, 2009

(30) Foreign Application Priority Data
Oct. 23, 2008 (DE) 10 2008 052 870.6

(51) Int. Cl. B26D 1/00; B26D 5/00

(52) U.S. Cl. 83/13; 83/72

(57) ABSTRACT

A method and apparatus for operating a microtome are described. According to the method, a specific type of a sample to be sectioned is detected, at least one stored sectioning parameter value is determined as a function of the specific type of the sample that was detected, said value being allocated to the specific type of the sample and defines a specific setting of the microtome, and the setting the microtome as defined by the determined sectioning parameter value is performed automatically.

### CROSS-REFERENCE TO RELATED APPLICATION

This application claims the priority of the German patent application DE 102008052870.6 having a filing date of Oct. 23, 2008. The entire content of this prior application DE 102008052870.6 is herewith incorporated by reference.

### BACKGROUND OF THE INVENTION

The invention relates to a method and an apparatus for operating a microtome. In this context, a type of a sample to be sectioned is detected.

Biological tissue samples, in particular histological tissue samples, are often required in the fields of human and veterinary medicine, in particular as prepared microscopy specimens for the assessment of cells and their environment. For microscopic inspection, thin sections of the tissue sample must be prepared and are assessed by an expert in incident light or transmitted light under the microscope. In order for thin sections to be produced with the aid of a microtome, the tissue sample must have a certain strength so that thin, transparent sections, having a thickness on the order of micrometers, can be produced using a knife of the microtome. For this purpose, the tissue samples are embedded in cassettes by means of an embedding medium, for example paraffin. For sectioning of the samples, the cassettes can then be arranged in corresponding holding apparatuses on the microtome.

Different settings must be made on the microtome depending on the sample type. For example, different sectioning speeds or different cooling conditions during the sectioning operation must be set as a function of the sample that is to be sectioned.

### SUMMARY OF THE INVENTION

It is an object of the invention to describe a method and an apparatus for operating a microtome that contribute to particularly simple, precise, and rapid work with the microtome.

According to the invention, this is achieved by a method for operating a microtome, comprising: detecting a specific type of a sample to be sectioned; determining at least one stored sectioning parameter value as a function of the specific type of the sample that was detected, said value being allocated to the specific type of the sample and defines a specific setting of the microtome; and automatically setting the microtome as defined by the determined sectioning parameter value.

Accordingly, the apparatus for operating a microtome comprises a detector for detecting a specific type of a sample to be sectioned; a data processor for determining at least one stored sectioning parameter value as a function of the specific type of the sample that was detected, said value being allocated to the specific type of the sample and defines a specific setting of the microtome; and a setting device for automatically setting the microtome as defined by the determined sectioning parameter value.

The invention is notable for a method and an apparatus for operating a microtome. In this context, a type of a sample to be sectioned is detected. As a function of the type that is detected, a stored sectioning parameter value is ascertained. The sectioning parameter value is allocated to the type, and is representative of a setting of the microtome. The ascertained sectioning parameter value is set automatically.

This contributes particularly effectively to simple, precise, and rapid work with the microtome, since the setting need not be performed manually by an operator of the microtome, but instead the microtome is set automatically in accordance with the type. The settings are thus performed automatically upon recognition of the type.

This enormously simplifies operation of the microtome, especially for inexperienced operators, since they have little or no experience as to how different settings need to be made for different samples. A “sample” in this connection preferably refers to a cassette having a tissue sample, the tissue sample being embedded by means of an embedding medium in the cassette, in particular a plastic cassette.

### DETAILED DESCRIPTION OF THE INVENTION

The sectioning parameter values are, for example, stored in a database and can be queried automatically on the basis of the type that is detected. The sectioning parameter value is the value of a sectioning parameter. Each different sectioning parameter corresponds to a different microtome setting possibility. Each sectioning parameter can assume different sectioning parameter values, as a function of the type. The type of the sample can also comprise subtypes to which separate sectioning parameters and/or separate sectioning parameters values can then be allocated.

In an advantageous embodiment, upon a change in the setting by an operator, a new sectioning parameter value that corresponds to the modified setting is allocated to the type. The new sectioning parameter value is stored in a manner allocated to the detected type. As a result, the sectioning parameter values are continuously updated until they are optimally set, and no further modification of the settings by the operator is necessary.

In a further advantageous embodiment, a frequency value is ascertained that is representative of how often, for the detected type, modification of the setting is performed by the operator in accordance with the new sectioning parameter value. The new sectioning parameter value is stored, in a manner allocated to the detected type, only when the frequency value is greater than a predefined threshold value. This helps ensure that the allocation of the sectioning parameter value to the type is modified not immediately on the basis of a setting modified in exceptional fashion, but instead only when it is clear that at least approximately, that new sectioning parameter value is regularly being set for the corresponding type.

In a further advantageous embodiment, an authorization of the operator is checked, and the new sectioning parameter value is allocated to the detected type only if the authorization meets at least one predefined condition. Experienced operators, for example, can be granted corresponding authorization to modify the allocated sectioning parameters. A modification of the setting by inexperienced operators then has no effect on the allocation of the sectioning parameter values to the types.

The stored sectioning parameter value can furthermore additionally be allocated to the operator. The sectioning parameter is then ascertained as a function of the detected type and the operator, and is set exclusively for the corresponding operator. In addition, the new sectioning parameter value can then be allocated exclusively to the operator who performed the corresponding modification of the setting. The settings can thus be stored in individual-operator fashion, so that operators who prefer settings differing from the norm can also work conveniently with the microtome.

The sectioning parameters comprise, for example, a trimming thickness, a trimming speed, a section thickness, a sectioning speed, a speed profile, a climate control of the sectioning area, and/or a relief angle setting on the blade holder.

### BRIEF DESCRIPTION OF THE DRAWINGS

Exemplifying embodiments of the invention are explained below with reference to the appended drawings, in which:

FIG. 1 shows an embedded tissue sample;

FIG. 2 is a flow chart of a first program for operating a microtome;

FIG. 3 is a flow chart of a second program for operating a microtome.

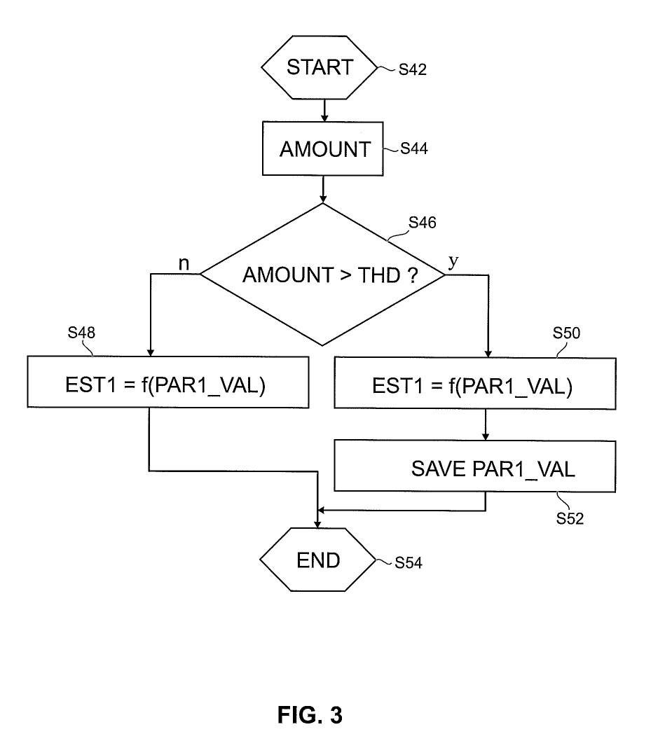

### DETAILED DESCRIPTION OF THE DRAWINGS

Elements having the same design or function are labeled with the same reference characters throughout the Figures.

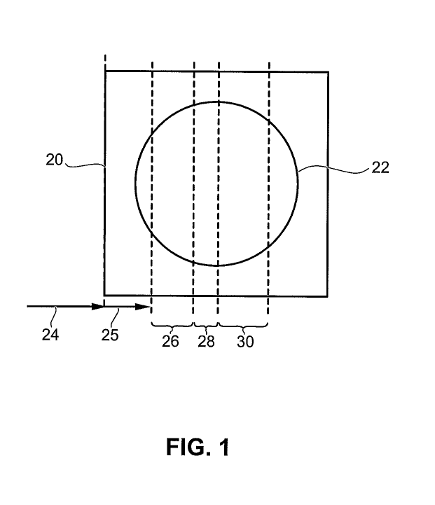

FIG. 1 shows a cassette 20 that is formed, for example, from plastic. A tissue sample 22 is embedded in cassette 20 by means of an embedding medium, for example paraffin. Tissue sample 22 can be at least partly penetrated by the embedding medium. The term “sample” refers hereinafter to cassette 20 having the embedded tissue sample 22. Tissue sample 22 is embedded in the embedding medium, and arranged in cassette 20, so that it can be sectioned with a microtome into very thin slices, for example having a thickness on the order of micrometers.

Different sample types differ, for example, by the fact that tissue sample 22 is a human or an animal tissue sample 22. Tissue samples 22 can furthermore be taken from different organs. The sections of the samples can furthermore be intended for different customers who have different customer-specific wishes. Different cassettes 20 can also be used.

Each of these, and further, properties of the sample require different settings of the microtome in order to achieve optimum sections. Each setting possibility of the microtome corresponds to a sectioning parameter. Each sectioning parameter can assume different sectioning parameter values. For example, different cassettes 20 can require, as a sectioning parameter, a different coarse drive mode 24 in accordance with which cassette 20 is, for example, moved out of a magazine toward a sectioning knife of the microtome. The sectioning parameter value for coarse drive mode 24 can be, for example, in the centimeter range. The respective organ, especially whether human or animal, from which tissue sample 22 derives can have an effect, for example, on the “cooling” sectioning parameter. The customer for whom the sections are being produced may desire, for example, sections having a certain minimum thickness.

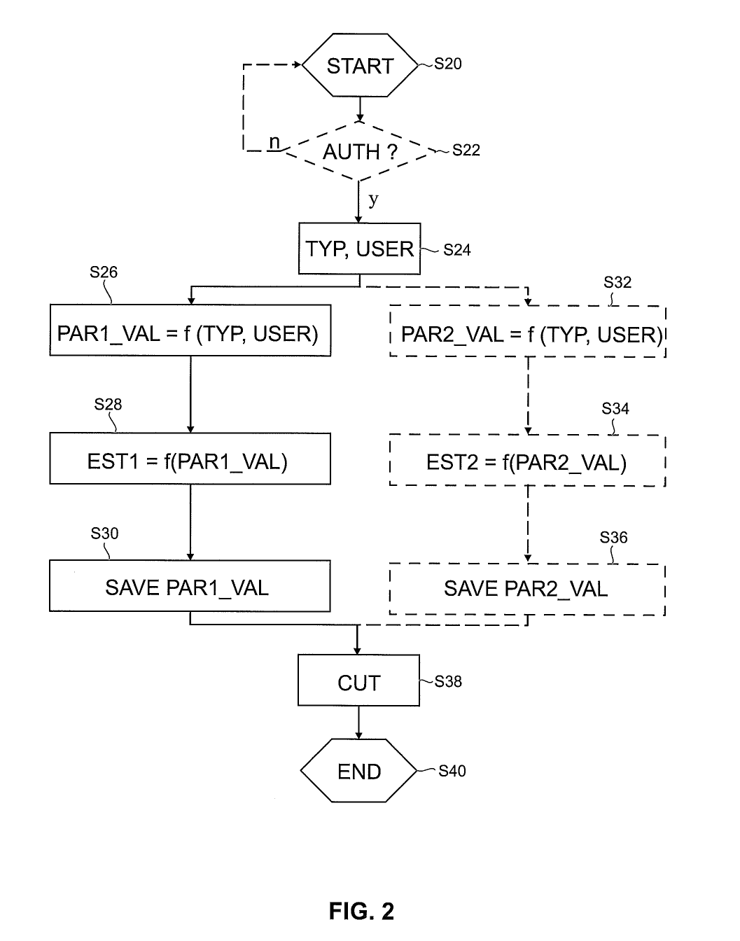

All the properties of the sample that are important for the microtome settings define a type TYP of the sample (FIG. 2). All samples of the same type TYP require the same microtome settings.

The type TYP of sample 22 can thus, for example, be representative of a tissue sample 22 from a human liver. Sectioning parameters that are important for liver tissue are, for example, a trimming thickness 25 within which no sections are to performed for the production of slices for investigation, a section thickness, and a cutting speed.

It is additionally possible to define a first and/or a second sectioning region 26 to 30 within which sample 22 is then sectioned into the slices having the section thickness. Further trimming regions 28 can also be constituted inside the sample, within which regions usable samples cannot be sectioned and in which a more rapid advance without sectioning then occurs. When these points are recognized, execution then proceeds not with micrometer-scale sectioning of slices, but only after a jump across a corresponding internal trimming thickness 28.

The speed profile refers to a speed at which the sectioning knife is moved relative to sample 20. Different sectioning parameter values of the speed profile can, for example, be representative of a uniform speed or of a differently accelerated speed or of the speed during the sectioning operation itself. Climate control can comprise multiple sectioning parameters, for example a temperature in the sectioning area or a humidity in the sectioning area.

Depending on the type TYP of sample 20, different settings must therefore be made on the microtome in order to achieve an optimum sectioning result. To ensure that the microtome can nevertheless be operated easily, precisely, and quickly, in particular even by an inexperienced employee, a control apparatus having automatic adjusting units for automatic execution of the settings is preferably coupled. The controller can also be referred to as an apparatus for operating the microtome.

A first program for operating the microtome, which program enables automatic setting of different sectioning parameter values, is preferably stored (FIG. 2) on a storage medium of the control apparatus.

The first program is preferably started in a step S20 in which variables are initialized as applicable.

In a step S22, an authorization of an operator USER of the microtome can be checked by means of an authorization query AUTH. If the operator USER is not correspondingly authorized, he or she can operate the microtome, but any modifications to microtome settings are not stored.

The type TYP of sample 20 is detected in a step S24. Sample 20 preferably comprises a code for this purpose. The code can be, for example, a barcode, a data matrix of sectioning parameter values, and/or an RFID chip. An operator USER of the microtome can also be ascertained, for example by way of a corresponding query, in step S24, especially if step S22 is not executed.

In a step S26, a first parameter value PAR1_VAL is ascertained as a function of the ascertained type TYP and, optionally, of the ascertained operator USER. The first parameter value PAR1_VAL refers, for example, to a centimeter indication of coarse drive mode 24. This makes it easy to use different cassettes 20 having different cassette sizes which each require a different coarse drive mode 24, the cassette type then being coded in the code. Ascertaining the first parameter value PAR1_VAL as a function of the operator USER allows different operators USER to use operator-specific settings on a regular basis and in simple fashion.

In a step S28, a first setting EST1 is performed as a function of the first parameter value PAR1_VAL that was ascertained. The first setting EST1 is performed, for example, by automatically displacing a stop for cassette 20.

The first setting EST1 can then be modified by the operator USER. If the first setting EST1 is modified by the operator USER, and if the operator USER is correspondingly authorized, the new first parameter value PAR1_VAL corresponding to the modified first setting EST1 is then stored in a step S30, by means of a storage instruction SAVE, in a manner allocated to the type TYP and/or to the operator USER.

In steps S32 to S36, correspondingly to steps S26 to S30, a second parameter value PAR2_VAL is ascertained and, as a function thereof, a second setting EST2 is performed. In addition, upon a modification of the second setting EST2 and with corresponding authorization of the operator USER, the second parameter PAR2_VAL is stored in a manner allocated to the type TYP and/or to the operator USER. In this connection, the second parameter value PAR2_VAL can refer, for example, to a section thickness of the sample slices to be sectioned subsequently.

All the settings that are possible in the context of the microtome can furthermore be set automatically in this fashion. Because identical types TYP of samples 20 are used on a regular basis, after an initial setting phase all the important settings of the microtome should be performed automatically, so that after the initial setting phase no, or almost no, manual modifications to the microtome are necessary. This makes working with the microtome enormously simpler and faster. In particular, even an inexperienced operator USER can work quickly and precisely with the microtome.

In a step S38, the sectioning operation is initiated with a sectioning instruction CUT, and the sections are carried out using the current settings.

The first program can be terminated in a step S40.

In addition, a second program for operating the microtome can also be stored on the storage medium of the control apparatus. The second program helps ensure that single modifications to the settings because of special exceptions result in a reallocation of sectioning parameter values to the types TYP not immediately, but instead only once a verification of the new settings occurs by way of a corresponding frequency of the modifications to the settings.

The second program is preferably started in a step S42, for example instead of the execution of steps S28 and S30 of the first program.

A step S44 ascertains a frequency value AMOUNT which represents how often, for the current type TYP, the corresponding setting was manually modified to the same final setting. The modified sectioning parameter values do not, in this context, need to be exactly identical in order for one of them to be recognized as a new sectioning parameter value. For example, an averaging over the new sectioning parameter values can be carried out, and the average can be stored as a new sectioning parameter value if an average deviation of the sectioning parameter values for a specific type TYP is less than a predefined deviation threshold value.

A step S46 checks whether the frequency value AMOUNT is greater than a predefined threshold value THD. If the condition of step S46 is not met, processing then continues in a step S48. If the condition of step S46 is met, processing then continues in a step S50.

In step S48, only the first setting EST1 is set as a function of the first parameter value PAR1_VAL. Storage of the new first sectioning parameter value PAR1_VAL, and allocation thereof to type TYP, do not occur.

In step S50, the first setting EST1 is performed as a function of the first ascertained parameter value PAR1_VAL.

In addition, in step S52, the first parameter value PAR1_VAL is stored by means of the storage instruction SAVE, in a manner allocated to the type TYP and/or to the operator USER.

The second program can be terminated in a step S54. Preferably, however, the first program is continued after step S54, for example in step S32. The second program can furthermore be executed for all the different settings, in particular repeatedly within the first program.

The invention is not limited to the exemplifying embodiments described. For example, more or fewer sectioning parameters can be set automatically. In addition, the first and the second program can be implemented in one program, or divided into further subprograms.

### LIST OF REFERENCE NUMERALS

20 Cassette
22 Tissue sample
24 Coarse drive mode
25 Trimming thickness
26 First sectioning region
28 Internal trimming thickness
30 Second sectioning region
START Program start
AUTH Authorization instruction
TYP Sample type
USER Operator
PAR1_VAL First sectioning parameter value
PAR2_VAL Second sectioning parameter value
EST1 First setting
EST2 Second setting
SAVE Storage instruction
CUT Sectioning instruction
END Program end
AMOUNT Frequency value
S20-S54 Steps one to fifty-four

1. A method for operating a microtome, comprising:
detecting a specific type of a sample to be sectioned;
determining at least one stored sectioning parameter value as a function of the specific type of the sample that was detected, said value being allocated to the specific type of the sample and defines a specific setting of the microtome; and
automatically setting the microtome as defined by the determined sectioning parameter value.

2. The method according to claim 1, comprising allocating a new sectioning parameter value to the specific type of sample upon a change in the settings of the microtome by an operator and storing the new sectioning parameter value such that it is allocated to the detected specific type of sample.

3. The method according to claim 2, comprising determining a frequency value that represents how often a modification of the setting of the microtome is performed by an operator for the detected specific type of the sample in accordance with the new sectioning parameter value; and storing the new sectioning parameter value such that it is allocated to the detected specific type of the sample only when the frequency value exceeds a predefined threshold value.

4. The method according to claim 2, comprising checking an authorization of the operator, and allocating the new sectioning parameter value to the detected specific type of the sample only if the authorization meets at least one predefined condition.

5. The method according to claim 2, comprising allocating the stored sectioning parameter value to the specific type of the sample and to a specific operator; and
determining the sectioning parameter value as a function of the detected specific type of the sample and of the specific operator.

6. The method according to claim 5, comprising allocating the new sectioning parameter value to the detected specific type of the sample and to the specific operator who performed the modification.

7. The method according to claim 1, comprising detecting the specific type of the sample by detecting a coded tag that the sample comprises.

8. The method according to claim 1, comprising storing two or more different sectioning parameter values each corresponding to different settings of the microtome.

9. The method according to claim 1, comprising providing as the settings of the microtome due to the respective sectioning parameter values at least one of a trimming thickness, a trimming speed, a section thickness, a sectioning speed, a speed profile, a climate control of the sectioning area, and a relief angle setting on the blade holder.

10. An apparatus for operating a microtome, comprising:
a detector for detecting a specific type of a sample to be sectioned;
a data processor for determining at least one stored sectioning parameter value as a function of the specific type of the sample that was detected, said value being allocated to the specific type of the sample and defines a specific setting of the microtome; and
a setting device for automatically setting the microtome as defined by the determined sectioning parameter value.
